(19) United States
(12) Patent Application Publication
(10) Pub. No.: US 2006/0233361 A1
(43) Pub. Date: Oct. 19, 2006

(54) Device, method, and program for encrypton and decryption and recording medium

(76) Inventors: Akio Hasegawa, Tokyo (JP); Song-Ju Kim, Tokyo (JP); Ken Umeno, Tokyo (JP)

Correspondence Address: BELL, BOYD & LLOYD, LLC, PO BOX 1135, CHICAGO, IL, 60690-1135, US

(21) Appl. No.: 10/545,739

(22) PCT Filed: Mar. 25, 2003
(86) PCT No.: PCT/JP03/03596

§ 371 Date: Feb. 6, 2006

(51) Int. Cl. H04L 9/00; H04K 1/06; H04K 1/04

(52) U.S. Cl. 380/42; 380/37

(57) ABSTRACT

A part of data is extracted as an IV from cipher text at the previous time. An EX-OR gate ORes the IV and a common key and outputs a cipher key. Data to be transmitted are encrypted with the cipher key according to stream cipher. When ciphered data 15a are obtained at time tn−1, an IV extracted from the ciphered data 15a is supplied to an EX-OR gate 11b. The EX-OR gate 11b exclusively ORes the IV and a common key 12b and outputs a cipher key 13b. Since the cipher key 13b and transmission data are exclusively ORed, encryption is performed according to the stream cipher. As a result, ciphered data 15b at time tn is obtained. Next, with the IV extracted from the ciphered data 15b, encryption at time tn+1 is performed. Thereafter, at each time, a part of cipher text is used as an IV. The encrypting process is repeated.

### BACKGROUND

The present invention relates to an encrypting and decrypting apparatus used for stream ciphering, a method thereof, a program thereof, and a recording medium thereof.

In recent years, as the Internet and mobile communication have been more widely used, the opportunities to transmit various types of data in wireless communication have increased. Since transmission data of the wireless communication can be easily monitored and tapped, it is essential to encrypt the transmission data. As a cryptographic technology, the common key system that uses the same secret key for an encrypting process and a decrypting process is known. The common key system is categorized as block cipher and stream cipher.

FIG. 1A describes the block cipher. Information bit sequence of plain text is divided by a predetermined length (into blocks). An encrypting apparatus 1 encrypts each block. Likewise, cipher text is divided into blocks.

On the other hand, as shown in FIG. 1B, in the stream cipher, random numbers generated by an encrypting apparatus (random number generator) 2 are operated on an information bit sequence bit by bit so as to generate cipher text.

In the stream cipher, when bit sequences of plain text are denoted by m1, m2, m3, . . . and so forth, bit sequences of random numbers are dented by r1, r2, r3, . . . and so forth, and bit sequences of cipher text are denoted by c1, c2, c3, . . . and so forth, the encrypting process is performed by ci=mi+ri (where + represents an operation of mod. 2; i=1, 2, 3, . . . and so forth). The decrypting process is performed by mi=ci+ri (where + represents an operation of mod. 2; i=1, 2, 3, and so forth). An operation of mod. 2 is expressed by an exclusive OR operation.

The transmission side and the reception side need to generate common random numbers. If random number sequences and random number generation patterns are leaked out, they can be easily decrypted. Thus, safe cipher random numbers used for cryptographic applications need to be statistically uniform. In addition, future random number sequences need to be difficult to be estimated with past random number sequences.

Generally, the steam cipher is performed faster than the block cipher. When large amount of data such as video data are encrypted and transmitted in real time, the stream cipher is more suitable than the block cipher. In addition, the circuit scale for the stream cipher is often smaller than that for the block cipher. Thus, although block ciphers such as DES (Data Encryption Standard), AES (Advanced Encryption Standard), and so forth have been standardized, the stream ciphers have been widely used.

For example, RC4 ((Rivest Cipher) 4 Stream Cipher) has been used for wireless LAN (IEEE 802.11). As cipher key generation algorithm, WEP (Wired Equivalent Privacy protocol) has been used. In the WEP, a cipher key is made up of an IV (Initial Vector) and a common key. With the cipher key, network packets (computer data) are encrypted.

When this method is used for a real time communication, as shown in FIG. 2, transmission data needs to contain cipher text and an IV. Thus, the amount of data to be transmitted increases. In addition, a portion that blocks an IV and cipher text needs to be newly created. Thus, it is necessary to largely change the existing system, for example the data rate of the existing system needs to be increased.

In addition, in the steam cipher, when the same cipher key is repeatedly used, the security of transmission data will be endangered. Thus, it is preferred that a cipher key be changed at predetermined intervals. To use other keys, namely to synchronize a cipher key between the transmission side and the reception side, a new signal is added. However, in this case, the amount of data to be transmitted increases.

Instead, if a cipher key is transmitted at intervals of a predetermined time period using a public key cryptographic system or the like, although the transmission side and the reception side can use different keys, data transmission need to be stopped to transmit a key. Thus, it becomes difficult to communicate in real time.

A cryptographic communication system that generates key generation information according to information of packet information of cipher text and generates cipher key and decipher key according to the key generation information and a master key is disclosed in Japanese Patent Laid-Open Publication No. 2000-224158. This patent document deals with a packet communication. Thus, it is difficult to apply the related art to a successive stream such as video data and audio data. To synchronize stream data, a synchronization signal is required. However, the related art as Japanese Patent Laid-Open Publication No. 2000-224158 does not describe it.

Therefore, an object of the present invention is to provide an encrypting and decrypting apparatus, a method thereof, a program thereof, and a recording medium thereof that can be applied to a continuous stream such as video data, that does not need to increase data to be transmitted, and that does not need to largely change the existing system.

### SUMMARY

Claim 1 of the present invention is a stream cipher encrypting apparatus that exclusively ORes key data and information data and generates cipher text, the encrypting apparatus comprising:

key data generation means for inputting a synchronization signal, extracting a part of data from cipher text at the preceding time, and generating key data with the extracted part of cipher text; and

encryption means for encrypting the information data with the key data.

Claim 7 of the present invention is a stream cipher encrypting method of exclusively ORing key data and information data and generating cipher text, the encrypting method comprising the steps of:

inputting a synchronization signal, extracting a part of data from cipher text at the preceding time, and generating key data with the extracted part of cipher text; and

encrypting the information data with the key data.

Claim 12 of the present invention is a program that causes a computer to execute a stream cipher encrypting method of exclusively ORing key data and information data and generating cipher text, the encrypting method comprising the steps of:

inputting synchronization data, extracting a part of data from cipher text at the preceding time, and generating key data with the extracted part of cipher text; and

encrypting the information data with the key data.

Claim 13 of the present invention is a computer readable recording medium on which the program that causes the computer to execute the stream cipher encrypting method.

Claim 14 of the present invention is a stream cipher decrypting apparatus that exclusively ORes cipher text and key data and decrypts the cipher text, the decrypting apparatus comprising:

key data generation means for inputting a synchronization signal, extracting a part of data from the cipher text at the preceding time, and generating key data with the extracted part of the cipher text; and

decryption means for decrypting the cipher text with the key data.

Claim 20 of the present invention is a stream cipher decrypting method of exclusively ORing cipher text and key data and decrypting the cipher text, the decrypting method comprising the steps of:

inputting a synchronization signal, extracting a part of data from the cipher text at the preceding time, and generating key data with the extracted part of the cipher text; and

decrypting the cipher text with the key data.

Claim 25 of the present invention is a program that causes a computer to execute a stream cipher decrypting method of exclusively ORing cipher text and key data and decrypting the cipher text, the decrypting method comprising the steps of:

inputting a synchronization signal, extracting a part of data from the cipher text at the preceding time, and generating key data with the extracted part of the cipher text; and

decrypting the cipher text with the key data.

Claim 26 of the present invention is a computer readable recording medium on which the program that causes the computer to execute the stream cipher decrypting method.

Additional features and advantages of the present invention are described in, and will be apparent from, the following Detailed Description and the figures.

### BRIEF DESCRIPTION OF THE FIGURES

FIG. 1 is a schematic diagram briefly describing conventional block cipher and stream cipher.

FIG. 2 is a schematic diagram showing the structure of transmission data for conventional ciphering.

FIG. 3 is a block diagram describing an encrypting apparatus according to the present invention.

FIG. 4 is a block diagram showing the structure of an encrypting apparatus according to the present invention.

FIG. 5 is a block diagram showing the structure of a decrypting apparatus according to the present invention.

FIG. 6 is a block diagram showing an example of the structure of a cipher key generation section.

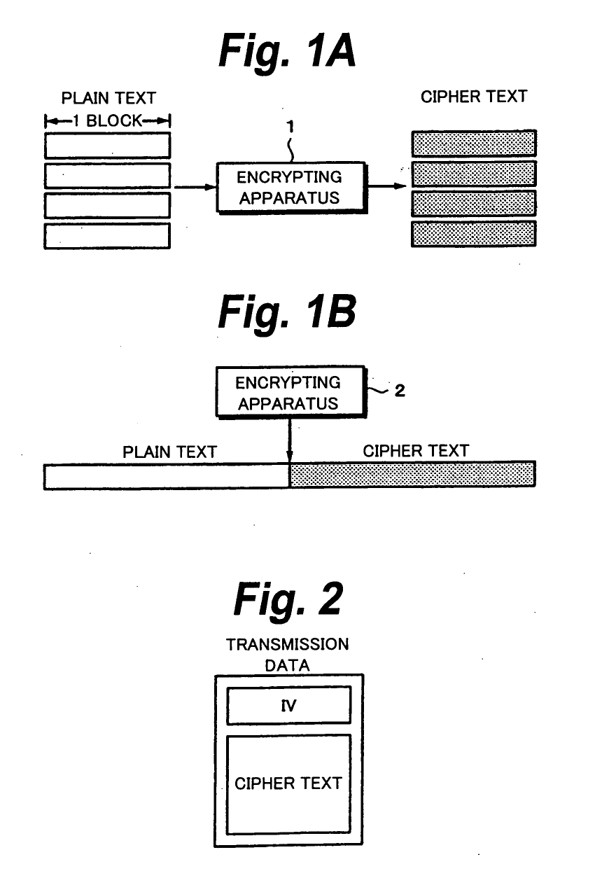

### DETAILED DESCRIPTION

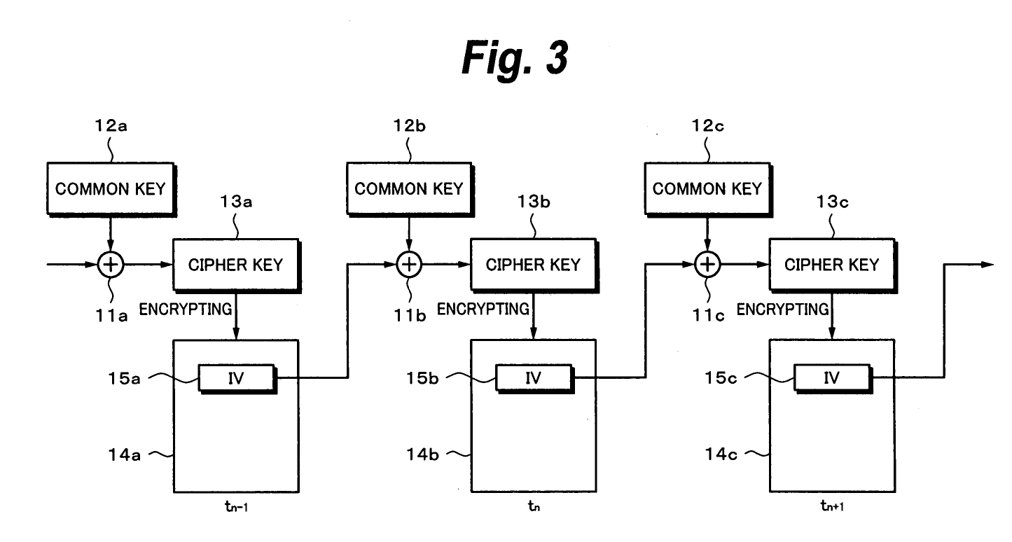

FIG. 3 shows an outline of an encrypting apparatus according to the present invention. Reference numeral 11a represents an exclusive OR gate (hereinafter sometimes referred to as an EX-OR gate) that inputs an IV having the same bit length as a cipher key of stream cipher extracted from cipher text. A common key 12a is also input to the EX-OR gate 11a. The common key 12a is a secret key that is shared by the transmission side and the reception side.

The transmission side and the reception side predecide a way of extracting an IV from cipher text. When for example video data are encrypted, it is predecided that a predetermined number of bits from a predetermined position of one frame, for example, from the beginning of one frame of valid video data is used as an IV. In this case, a time interval is a frame period.

The EX-OR gate 11a outputs a cipher key 13a. With the cipher key 13a, data to be transmitted, for example video data, are encrypted according to the stream cipher. Reference numeral 15a represents cipher text (ciphered data). The cipher key 13a and transmission data are exclusively ORed for one bit or a plurality of bits at a time. As a result, they are encrypted.

When the cipher text 15a is obtained at time tn−1, an IV extracted from the cipher text 15a is supplied to an EX-OR gate 11b. The EX-OR gate 11b exclusively ORes the IV and a common key 12b. The EX-OR gate 11b outputs a cipher key 13b. The cipher key 13b and transmission data are exclusively ORed for one bit or a plurality of bits at a time. As a result, they are encrypted according to the stream cipher. At time tn, cipher text 15b is obtained.

When the cipher text 15b is obtained at time tn, an IV extracted from the cipher text 15b is supplied to an EX-OR gate 11c. The EX-OR gate 11c exclusively ORes the IV and a common key 12c. The EX-OR gate 11c outputs a cipher key 13c. The cipher key 13c and transmission data are exclusively ORed for one bit or a plurality of bits at a time. As a result, they are encrypted according to the stream cipher. Thus, at time tn+1, a cipher text 15c is obtained.

Thereafter, at each time, with a part of generated cipher text used as an IV, the encrypting process is repeatedly performed. Thus, besides cipher text, it is not necessary to transmit an IV as transmission data.

A decryption section of the reception side extracts a portion corresponding to an IV from data that have been received at one-step earlier time and stores this portion. This portion and a common key shared by the reception side are exclusively ORed. As a result, a cipher key is generated. With the cipher key, the cipher text is decrypted.

At the first time of the encryption process, since cipher text has not been obtained, an exception process that uses predetermined data as an IV is required.

Since ciphered data that are transmitted vary as time elapses, an IV also varies as time elapses. Thus, since a cipher key used in the stream cipher is generated according to an IV, the cipher key can be varied as time elapses without need to vary the common key. Thus, data can be safely encrypted. In addition, since an IV is extracted from cipher text that was transmitted or received at one-step earlier time, a signal that synchronizes a key does not need to be transmitted. While cipher text is being transmitted or received, an IV can be extracted. Thus, no over head with respect to time takes place. Since the present invention has the foregoing features, the existing real time communication means can be used without need to modify it. In addition, according to the present invention, realtimeness of data transmission is not lost.

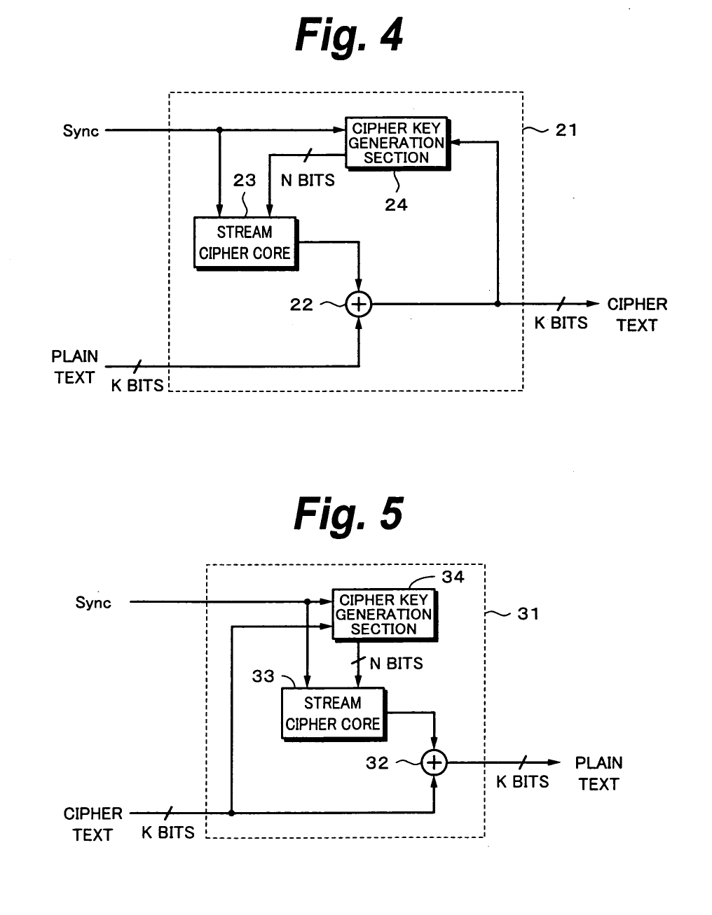

FIG. 4 shows the structure of an encryption section of the transmission side. Reference numeral 21 represents the whole encryption section. Plain text of k bits is supplied to an EX-OR gate 22. A stream key of k bits is supplied from a stream cipher core 23 to the EX-OR gate 22. The EX-OR gate 22 outputs cipher text.

The cipher text that is output from the EX-OR gate 22 is transmitted and fed back to a cipher key generation section 24. The cipher key generation section 24 has a common key of n bits. A part of data of the cipher text is used as an IV. A cipher key is made up of the common key and the IV. The generated cipher key is sent to the stream cipher core 23. The stream key is supplied from the stream cipher core 23 to the EX-OR gate 22. The EX-OR gate 22 encrypts the stream key.

As an example, the cipher key generation section 24 generates a cipher key having a length of 480 bits arranged in parallel. A steam key of 40 bits is made up of the cipher key. The EX-OR gate 22 exclusively ORes plain text arranged every 40 bits in parallel and a stream key of 40 bits supplied from the stream cipher core 23.

A synchronization signal (Sync) is supplied to the stream cipher core 23 and the cipher key generation section 24. A key is updated at intervals of a time period according to the synchronization signal. When video data are handled, as the synchronization signal (Sync), a frame synchronization signal or a vertical synchronization signal may be used.

The cipher key and plain text may be exclusively ORed for one bit at a time. However, according to the embodiment, when the encrypting process is performed in parallel, the encryption speed can be increased.

FIG. 5 shows the structure of a decryption section of the reception side. Reference numeral 31 represents the whole decryption section. Received cipher text is supplied to an EX-OR gate 32. A stream key is supplied from a stream cipher core 33 to the EX-OR gate 32. The EX-OR gate 32 outputs plain text.

Cipher text is also input to an cipher key generation section 34. The cipher key generation section 34 has a common key. A cipher key having a length of 480 bits arranged in parallel is made up of a part of cipher text as an IV and the common key. The cipher key is supplied to the stream cipher core 33. The stream cipher core 33 generates a stream key of 40 bits. The EX-OR gate 32 exclusively ORes cipher text arranged every 40 bits in parallel and a stream key and outputs plain text. At the same point, the cipher key generation section 34 extracts an IV for the decrypting process for the next step from the received cipher text and stores the IV.

A synchronization signal (Sync) is supplied to the stream cipher core 33 and the cipher key generation section 34. A key is updated at intervals of a time interval according to the synchronization signal.

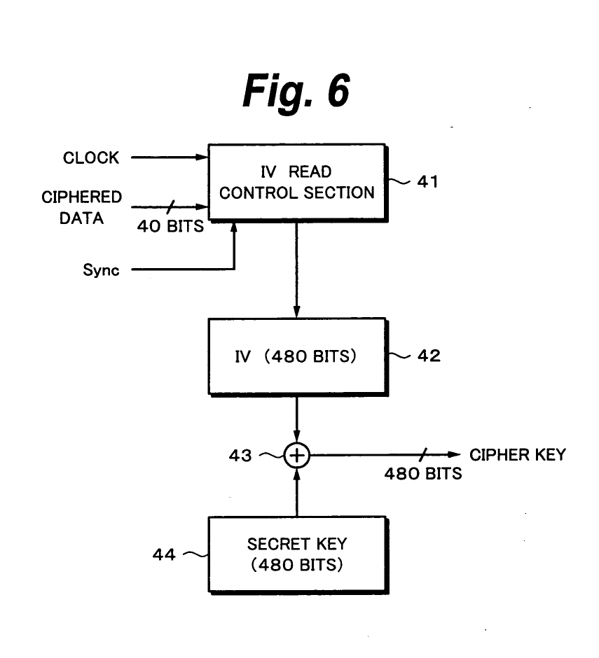

FIG. 6 shows an example of the structure of the cipher key generation section 24. The structure of the cipher key generation section 24 is the same as that shown in FIG. 6. Reference numeral 41 represents an IV read control section. A clock, ciphered data, and a synchronization signal (Sync) are supplied to the read control section. For example, ciphered data are read for 40 bits at a time in synchronization with the clock. Predetermined data corresponding to an IV are extracted from the ciphered data.

An extracted IV 42 of for example 480 bits and a secret key 44 of 480 bites are supplied to an EX-OR gate 43. The EX-OR gate 43 outputs a cipher key of 480 bits.

As described above, according to the present invention, a part of ciphered data that vary as time elapses is used as an IV. Thus, the IV can be varied as time elapses. Thus, without need to change a common key, a cipher key used in the stream cipher can be varied as time elapses. Thus, data can be safely encrypted. In addition, according to the present invention, an IV is extracted from cipher text that was transmitted or received at one-step earlier step. Thus, since other keys are used at intervals of a predetermined time period, a signal that synchronizes a key does need to be transmitted. When a cipher key is transmitted using a public key cryptographic system or the like at intervals of a predetermined period, the transmission side and the reception side can use other keys. However, data transmission needs to be stopped to transmit a key. Thus, it becomes difficult to communicate in real time. According to the present invention, since an IV can be extracted while cipher text is being transmitted or received, no over head with respect to time takes place. Thus, the existing real time communication means can be used without need to modify it. In addition, realtimeness of data transmission is not lost.

The present invention is not limited to the foregoing embodiment. Without departing from the spirit and scope of the present invention, various modifications and ramifications of the present invention may be made. In other words, the key length of the foregoing cipher key is just an example. Instead, a cipher key having any key length may be used. A portion of cipher text from which an IV is extracted is not limited to one frame of a video signal, but any length, for example one field. The present invention can be applied to encryption of information data such as music data besides video data. In FIG. 4 and FIG. 5, without the stream cipher cores 23 and 33, cipher keys generated by the cipher key generation sections 24 and 34 may be supplied to the EX-OR gates 22 and 32, respectively.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A stream cipher encrypting apparatus that exclusively ORes key data and information data and generates cipher text, the encrypting apparatus comprising:
key data generation means for inputting a synchronization signal, extracting a part of data from cipher text at the preceding time, and generating key data with the extracted part of cipher text; and
encryption means for encrypting the information data with the key data.

2. The encrypting apparatus as set forth in claim 1,
wherein the key data are generated with the part of the data and a common key.

3. The encrypting apparatus as set forth in claim 1,
wherein the information data are stream data, the synchronization signal is a synchronization signal for stream data, and the key data is generated in synchronization with the synchronization signal of the stream data.

4. The encrypting apparatus as set forth in claim 3,
wherein the stream data are video data.

5. The encrypting apparatus as set forth in claim 3,
wherein the stream data are audio data.

6. The encrypting apparatus as set forth in claim 1,
wherein the key data generation means and the encryption means are accomplished on an integrated circuit.

7. A stream cipher encrypting method of exclusively ORing key data and information data and generating cipher text, the encrypting method comprising the steps of:
inputting a synchronization signal, extracting a part of data from cipher text at the preceding time, and generating key data with the extracted part of cipher text; and
encrypting the information data with the key data.

8. The encrypting method as set forth in claim 7,
wherein the key data are generated with the part of the data and a common key.

9. The encrypting method as set forth in claim 7,
wherein the information data are stream data, the synchronization signal is a synchronization signal for stream data, and the key data is generated in synchronization with the synchronization signal of the stream data.

10. The encrypting method as set forth in claim 9,
wherein the stream data are video data.

11. The encrypting method as set forth in claim 9,
wherein the stream data are audio data.

12. A program that causes a computer to execute a stream cipher encrypting method of exclusively ORing key data and information data and generating cipher text, the encrypting method comprising the steps of:
inputting synchronization data, extracting a part of data from cipher text at the preceding time, and generating key data with the extracted part of cipher text; and
encrypting the information data with the key data.

13. A computer readable recording medium on which a program that causes a computer to execute a stream cipher encrypting method of exclusively ORing key data and information data and generating cipher text has been recorded, the encrypting method comprising the steps of:
inputting synchronization data, extracting a part of data from cipher text at the preceding time, and generating key data with the extracted part of cipher text; and
encrypting the information data with the key data.

14. A stream cipher decrypting apparatus that exclusively ORes cipher text and key data and decrypts the cipher text, the decrypting apparatus comprising:
key data generation means for inputting a synchronization signal, extracting a part of data from the cipher text at the preceding time, and generating key data with the extracted part of the cipher text; and
decryption means for decrypting the cipher text with the key data.

15. The decrypting apparatus as set forth in claim 14,
wherein the key data are generated with the part of the data and a common key.

16. The decrypting apparatus as set forth in claim 14,
wherein the information data are stream data, the synchronization signal is a synchronization signal for stream data, and the key data is generated in synchronization with the synchronization signal of the stream data.

17. The decrypting apparatus as set forth in claim 16,
wherein the stream data are video data.

18. The decrypting apparatus as set forth in claim 16,
wherein the stream data are audio data.

19. The decrypting apparatus as set forth in claim 14,
wherein the key data generation means and the decryption means are accomplished on an integrated circuit.

20. A stream cipher decrypting method of exclusively ORing cipher text and key data and decrypting the cipher text, the decrypting method comprising the steps of:
inputting a synchronization signal, extracting a part of data from the cipher text at the preceding time, and generating key data with the extracted part of the cipher text; and
decrypting the cipher text with the key data.

21. The decrypting method as set forth in claim 20,
wherein the key data are generated with the part of the data and a common key.

22. The decrypting method as set forth in claim 20,
wherein the information data are stream data, the synchronization signal is a synchronization signal for stream data, and the key data is generated in synchronization with the synchronization signal of the stream data.

23. The decrypting method as set forth in claim 22,
wherein the stream data are video data.

24. The decrypting method as set forth in claim 22,
wherein the stream data are audio data.

25. A program that causes a computer to execute a stream cipher decrypting method of exclusively ORing cipher text and key data and decrypting the cipher text, the decrypting method comprising the steps of:
inputting a synchronization signal, extracting a part of data from the cipher text at the preceding time, and generating key data with the extracted part of the cipher text; and
decrypting the cipher text with the key data.

26. A computer readable recording medium on which a program that causes a computer to execute a stream cipher decrypting method of exclusively ORing cipher text and key data and decrypting the cipher text has been recorded, the decrypting method comprising the steps of:
inputting a synchronization signal, extracting a part of data from the cipher text at the preceding time, and generating key data with the extracted part of the cipher text; and
decrypting the cipher text with the key data.
